(19) United States
(12) Patent Application Publication
(10) Pub. No.: US 2006/0004726 A1
(43) Pub. Date: Jan. 5, 2006

(54) System for processing a data request and related methods

(76) Inventor: Michael Blank, New York, NY (US)

Correspondence Address: DOCKET ADMINISTRATOR;LOWENSTEIN SANDLER PC, 65 LIVINGSTON AVENUE, ROSELAND, NJ, 07068, US

(21) Appl. No.: 11/154,762

(22) Filed: Jun. 16, 2005

Related U.S. Application Data
(60) Provisional application No. 60/580,191, filed on Jun. 16, 2004.

(51) Int. Cl. G06F 17/30

(52) U.S. Cl. 707/3

(57) ABSTRACT

In a system and a method for processing a data request, a data request is received in an e-mail, text-message, or other format from a communication device. The request may be validated to ensure that the request is coming from an authorized user. The data request is translated into a query having a format understandable to a data storage system, and the query is submitted to the data storage system. A response to the query is received and translated into a translated response having a format understandable by the communication device. The translated response is transmitted to the communication device. A user of the communication device may pay a fee for receiving the translated response.

### CROSS REFERENCE TO RELATED APPLICATION

This application claims the benefit of U.S. Provisional Application No. 60/580,191, filed Jun. 16, 2004, the entire disclosure of U.S. Provisional Application No. 60/580,191 is hereby incorporated herein by reference.

### FIELD OF THE INVENTION

This invention relates to processing a data request. In particular, this invention pertains to processing a data request having, for example, an e-mail or SMS message format. Such processing allows a device having relatively limited communication schemes, such as a hand-held mobile phone designed to communicate using voice, e-mail, and/or SMS messaging, to receive a variety of data in formats that may be determined by the device's user.

### BACKGROUND OF THE INVENTION

With the advancement in mobile communications technology and the decrease in the physical size of processors, it has become commonplace for people to carry mobile-phones, hand-held integrated e-mail devices, two-way pagers, PDAs, etc., having significant computing power. Today's mobile communication devices typically have the ability not only to place phone calls, but also to store contact information, view and send e-mails, and receive and send SMS (“text”) messages. However advanced today's mobile communication devices are, they still have not attained the processing power and data storage capabilities of a server, a desktop computer, a laptop computer, or other high-powered computer. Vast amounts of important information are stored on these high-powered computers, and immediate access to such information often is required. However, most of this information is not readily accessible to someone carrying only a mobile communication device, let alone in an immediate time frame.

Accordingly, a need in the art exists for a simple, flexible, and efficient way to remotely access a wide variety of data using mobile communication devices.

### SUMMARY OF THE INVENTION

The above-described problem is addressed and a technical solution is achieved in the art by a system and a method for processing a data request, according to the present invention. In an embodiment of the present invention, a processing system receives a data request in an e-mail, a text-message, or other format from a device. The device may be, but is not limited to, a mobile communication device, such as a mobile phone, hand-held integrated e-mail device, two-way pager, or PDA. The request may be validated to ensure that the request is arriving from an authorized user. The processing component translates the request into a query having a format understandable by a data storage system. The processing system submits the query to the data storage system and receives a response to the query from the data storage system. The processing system translates the response into a translated response having a format understandable by the device. The translated response may have an e-mail or text-message format, depending on which format was used for the data request. However, the translated response may have any format, such as an image file format or a sound file format, depending upon the type of data requested and the capabilities of the device. The processing component transmits the translated response to the device. Advantageously, the translated response is transmitted to the device in real-time.

According to an embodiment of the present invention, the data storage system comprises a database system, and the query format and the response format are an SQL format, a Microsoft Access™ format, or other database system format compatible with the database system. According to another embodiment of the present invention, the data storage system includes a Web server, and the query format and the response format are a hypertext transfer protocol (“HTTP”) format. According to this embodiment, the query is submitted to the Web server, which interacts with the database system to obtain the response. The response then is received from the Web server. Also according to the embodiment, the response may have an XML format.

According to yet another embodiment of the present invention, a type of the request is determined by an address to which the request is sent without the use of a start and an end tag in the request.

According to another embodiment of the present invention, the query serves as a command to perform certain computing functions on a receiving server, and the translated response is the outcome of these computing functions. For example, the query may be a request to perform a web-based search, such as a search performed by a search engine, wherein the translated response includes the search results.

According to still another embodiment of the present invention, a user of the device pays a fee in order to gain access to the functionality provided by the processing system. The user may gain access to such functionality regardless of what entity, such as a communication service provider, provides the user with an ability to communicate using the device.

By processing data requests having an e-mail or text-message format, the present invention allows a mobile communication device or other remote device to easily request and immediately receive a variety of information stored by high-powered computers, such as server computers, desktop computers, laptop computers, etc., communicatively connected to the mobile communication device.

### BRIEF DESCRIPTION OF THE DRAWINGS

The present invention will be more readily understood from the detailed description of preferred embodiments presented below considered in conjunction with the attached drawings, of which:

FIG. 1 illustrates an environment in which a processing system, according to an embodiment of the present invention, operates; and

FIG. 2 illustrates a process flow executed by the processing system of FIG. 1, according to an embodiment of the present invention.

### DETAILED DESCRIPTION OF THE INVENTION

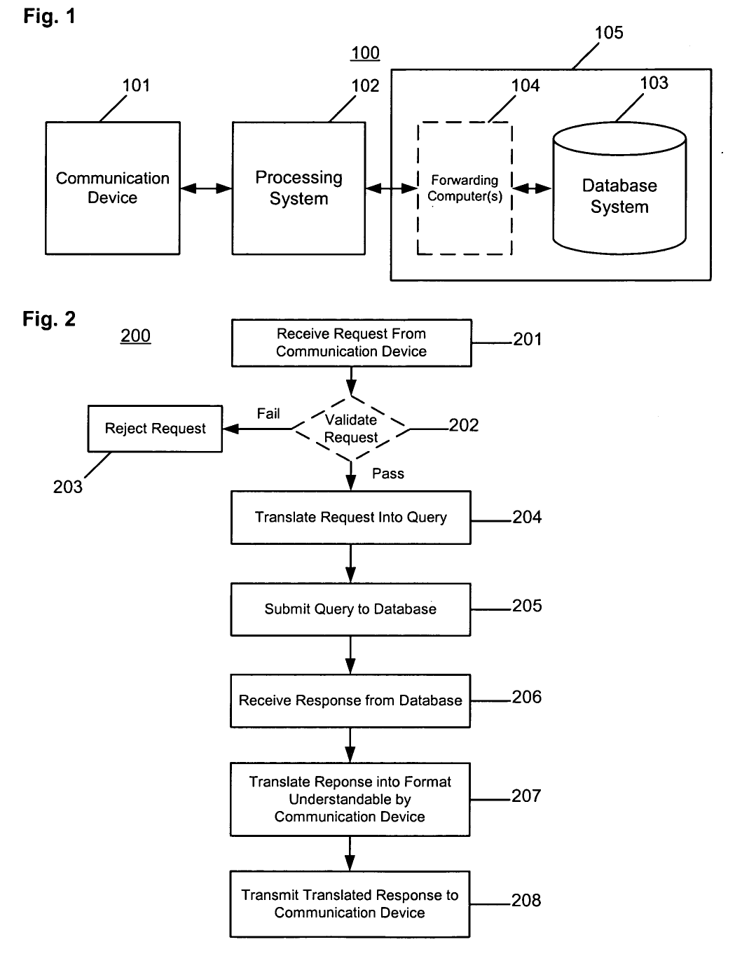

FIG. 1 illustrates an environment 100 in which a processing system 102 operates, according to an embodiment of the present invention. The environment 100 includes a communication device 101 communicatively connected to the processing system 102, and a data storage system 105 also communicatively connected to the processing system 102. The phrase “communicatively connected” is intended to include any type of connection, whether wired, wireless, or both, between devices and/or programs in which data may be communicated. Further, the phrase “communicatively connected” is intended to include a connection between devices and/or programs within a single computer, a connection between devices and/or programs located in different computers, or a connection between devices not located in computers at all.

The communication device 101 may be a computer or device capable of communicating via e-mail, SMS (“text”) messages, or both. According to an embodiment of the present invention, the communication device 101 is a mobile wireless communication device, such as a mobile phone, a hand-held integrated e-mail device, a two-way pager, a PDA, a BlackBerry™, etc. Although this invention is described in the context of a mobile wireless communication device, one skilled in the art will appreciate that any device communicating via e-mail, text-messages, or both, may be used in place of the communication device 101.

The processing system 102 receives e-mail requests, text-message requests, or both, from the communication device 101, and transmits a response back to the communication device 101 in the format of the request. The processing system 102 may include one or more computers executing one or more programs that implement the method 200 described below with reference to FIG. 2. The term “computer” is intended to include any data processing device, such as a desktop computer, a laptop computer, a mainframe computer, a personal digital assistant, a BlackBerry, and/or any other device for processing data, and/or managing data, and/or handling data, whether implemented with electrical and/or magnetic and/or optical and/or biological components, or otherwise. According to an embodiment of the present invention, however, the processing system 102 includes one or more computers having more processing power and/or storage capabilities than a mobile communication device.

As described in detail below, the processing system 102 submits the request from the communication device 101 in a modified form to the data storage system 105. The processing system 102 then receives a response to the request from the data storage system 105, modifies the response, and forwards the response to the communication device 101, preferably, in real-time.

The data storage system 105 includes a database system 103, which includes one or more computer-accessible memories storing data retrievable by the communication device 101. The phrase “computer-accessible memory” is intended to include any computer-accessible data storage device, whether volatile or nonvolatile, electronic, magnetic, optical, or otherwise, including but not limited to, floppy disks, hard disks, CD-ROMs, DVDs, flash memories, ROMs, and RAMs. Although shown separately from the processing system 102 for clarity, the database system 103 may be located completely or partially within the processing system 102. For instance, all or part of the database system 103 may be stored on a hard disk within a computer in the processing system 102.

Further, one or more computers or other devices (“forwarding computer(s)”) 104 may be located between the database system 103 and the processing system 102, such that the forwarding computer(s) 104 act(s) to forward requests received from the processing system 102 to the database system 103 and forward(s) responses from the database system 103 to the processing system 102. In this regard, the forwarding computer(s) 104 may include a Web server, which receives Web-based requests, such as HTTP requests, known in the art, and submits such requests to the database system 103. Responses from the database system 103 are received by the Web server and forwarded to the processing system 102. The Web server may alternatively be included in the processing system 102. For instance, the Web server may act as an intermediate computer in the processing system 102 interfacing the one or more computers executing the method 200 and the database system 103.

The database system 103 may include any form of database, such as an SQL database or a Microsoft Access database. However, the database system 103 need not include a formal database and may include any stored data, such as images, text, music, or other files stored in a computer-accessible memory. The content of the database system 103 advantageously is updated in real-time to provide, for example, current scores of sporting events, stock quotes, or other dynamic information.

The method 200 of processing a request from the communication device 101 will now be described in detail with reference to FIGS. 1 and 2. The method 200 may be implemented by one or more programs executed by one or more computers in the processing system 102, A user of the communication device 101 initiates a request for information by inputting text data in the form of an e-mail or text-message, known in the art, into the communication device 101. As well as inputting the request into the communication device 101, the user also addresses the request to the processing system 102. In the scenario where the request is in an e-mail format, the request is addressed to an e-mail address that is monitored by the processing system 102. In the scenario where the request is in a text-message format, the request is addressed to a phone number to which the processing system 102 responds. After the request is input and addressed, the user transmits the request via the communication device 101 to the processing system 102, and the request is received by the processing system 102, as shown at step 201 in FIG. 2.

The request indicates a type of information requested, such as stock information, and an object for which the requested information is sought, such as stock information for company “ZZZ.” The type of information requested and the object for which the information is sought may be indicated by the address to which the request is sent, the content of the request, or both. According to an embodiment of the present invention, the address to which the request is sent indicates both the type of information requested and the object for which the requested information is sought. For example, a user may send a request in an e-mail addressed to: “yankees_score@somecompany.com” to obtain a current baseball score for a Yankee™ game. In this example, the address “yankees_score@somecompany.com” indicates both the type of information requested (baseball scores) and the object for which the requested information is sought (the Yankees baseball team). Alternatively, a user may send a text-message to a particular phone number reserved for obtaining a current stock quote for a particular company. According to this embodiment, the user need only send a blank request to a particular address to receive their desired information. However, many address may be required.

According to another embodiment of the present invention, both the address to which the request is sent and the content of the request are used to indicate the type of information requested and the object for which the information is sought. In particular, the addresses are more generic, and, consequently, fewer addresses are needed than the embodiment discussed immediately above. However, the user of the communication device 101 must enter some information as content in the request. For example, a user may send a request in an e-mail addressed to: “baseball@somecompany.com”, and in the request, the user may type “yankees” to obtain a current baseball score for a Yankee™ game. In this example, the address indicates the type of information requested (baseball scores), and the content of the request indicates the object for which the requested information is sought (the Yankees baseball team). Alternatively, a user may send a text-message to a particular phone number reserved for obtaining current stock quotes, and in the text-message, the user may type “ZZZ” to obtain a stock quote for company ZZZ.

According to yet another embodiment of the present invention, only the content of the request is used to indicate the type of information requested and the object for which the information is sought. In particular, a generic address may be used, but the user of the communication device 101 must enter more information as content in the request than the embodiment described immediately above. For example, a user may send a request in an e-mail addressed to: “information@somecompany.com” and type into the body of the e-mail “stock ZZZ” to obtain a current stock quote for company ZZZ. In this example, the word “stock” indicates the type of information requested, and “ZZZ” indicates the object for which the information is sought. Alternatively, a user may send a text-message to a particular phone number, and in the text-message, the user may type “stock ZZZ” to obtain a stock quote for company ZZZ.

The request also may contain a command for additional information relating to a previous request. Preferably, the request for additional information has the same less complexity than the previous request, and, consequently, is relatively simple for the user to make. For instance, assume that a user's first e-mail request contained the text “ZZZ” and was sent to “stocks@somecompany.com”. Due to the limited storage and display capabilities of many communication devices 101, the processing system 102 advantageously returns a finite set of data, such as the current stock price, daily and fifty-two week highs and lows, and trading volume of stock ZZZ. If the user wants additional information, he or she may send a request containing the text “+”, for example, to the same address as the first request. The processing system 102 matches the “more” request with the initial request and sends additional information pertaining to stock ZZZ, such as recent news.

One skilled in the art will appreciate that the invention is not limited to the request format described above and that many other formatting conventions will operate equally well without departing from the scope of the invention. Further, it is advantageous to allow the user of the communication device 101 to define a personal formatting convention, such as custom information types, objects for which the requested information is sought, and commands. These personal formatting conventions may be input via a Website or other user interface and stored in the data storage system 105.

Once the request is received by the processing system 102, as shown at step 201 in FIG. 2, the request optionally is validated at step 202. In particular, the processing system 102 inspects the return address of the request, i.e., the address of the communication device 101, and compares it to a subscriber list stored in the data storage system 105, which includes authorized addresses. The subscriber list is used by the processing system 102 to ensure that only authorized users have access to the information in data storage system 105. For e-mail requests, the subscriber list includes authorized e-mail addresses, and for text-message requests, the subscriber list includes authorized phone numbers. If the address of the communication device 101 does not match an address in the subscriber list at step 202, it is determined that the request is not coming from an authorized user, and the request is rejected at step 203. Such rejection may take the form of an error message sent back to the communication device 101 with information on how to subscribe to the processing system 102. Alternatively, the request may be neglected to indicate such rejection. If the address of the communication device 101 matches an address in the subscriber list at step 202, the request is validated, and processing advances to step 204. Or, if validation at step 202 is omitted, processing advances directly from step 201 to step 204.

At step 204, the request is parsed and translated into a query understandable by either at least one of forwarding computer(s) 104 or the database system 103, depending upon whether the forwarding computer(s) 104 is/are present. If a Web server is included in the forwarding computer(s) 104, the request is translated into a hypertext transfer protocol (HTTP) request. In this scenario, the Web server performs the additional task of using the HTTP request to access the database system 103, such as converting the HTTP request into a request understandable by the database system 103, or forwarding the request to an application server that then converts the HTTP request into a request understandable by the database system 103.

If no forwarding computer(s) 104 is/are used, the processing system 102 itself translates the request into a format understandable by the database system 103. In particular, the request is translated into an SQL, Access, or other query format depending upon the relevant database type in the database system 103. If the database system 103 is not a formal database and represents images, text, music, or other files stored on a computer-accessible memory, the processing system 102 translates the request into a file retrieval or file access command understandable by an operating system controlling the relevant computer-accessible memory.

Once translated, the processing system 102 submits the query to the database system 103, either directly or via the forwarding computer(s) 104, as shown at step 205. A response to the query from the database system 103 is received by the processing system 102 either directly or via the forwarding computer(s) 104, as shown at step 206. If a Web server is included in the forwarding computer(s) 104, the response is in an HTTP format and may include an XML document containing the data requested by the query. If no forwarding computer(s) 104 is/are present, the response is in the native format of the database system 103, such as SQL, Access, etc., depending upon the relevant database type in the database system 103.

At step 207, the processing system 102 translates the response into an appropriate format based upon the capabilities of the communication device 101 and the desired data type of the response. Most commonly, the response is translated into an e-mail message or a text-message, whichever was used in the received request at step 201. For example, assume that the stock price for company “ZZZ” was requested via e-mail, and the database system 103 returned: “$34.56 (−0.52) 3,104,600 shrs. Today: $34.50-35.18. 52 wk: $31.10-41.34. DJIA $10,180.87 (−24.33). NASDAQ $1,983.92 (−0.58).” The processing system 102 may convert this information into an e-mail containing the text “ZZZ $34.56 (−0.52) 3,104,600 shrs. Today: $34.50-35.18. 52 wk: $31.10-41.34. DJIA $10,180.87 (−24.33). NASDAQ $1,983.92 (−0.58).”

However, the format of the translated response also depends upon the desired data type of the response. For instance, if a text file was requested via a text-message, and the database system 103 returned the text file, the contents of the text file may be converted into a text-message. Alternatively, if an image file was requested via an e-mail, and the database returned the requested image file, the image file may be sent directly to the communication device 101 for display, or it may be attached to an e-mail sent back to the communication device 101. Sound files may be treated in the same manner in that they may be sent directly to the communication device 101 for immediate playing or attached as a separate file. Whatever the format, the translated response is addressed to the communication device 101 and is sent at step 208, thereby fulfilling the request from the user of the communication device 101.

Advantageously, the method 200 occurs in real-time. The elapsed time from step 201 to step 208 is limited by the communication speed between the communication device 101, the processing system 102, the forwarding computer(s) 104, and the database system 103. The elapsed time also depends upon the processing power of these components, as well as any other factors that normally affect networks and computing systems. In this regard, the phrase “real-time” is intended to refer to a short enough period of time between a request and a response, taking into account the size and/or importance of the response, such that waiting for the response does not unduly burden the resources of the communication device 101 or the resources of a user of the communication device 101.

According to another embodiment of the present invention, a plurality of communication devices 101 respectively are owned by a plurality of users. The users apply to an information provider for access to the processing system 102. The users may apply via a Web site, however, one skilled in the art will appreciate that users may apply via telephone, mail, in-person visits to a place of business, or other types of communication. Once approved, each of the users pays a fee in return for access to the processing system 102. The fee may entitle the corresponding user to submit unlimited requests to the processing system 102 for a predetermined period of time, such as one month. One skilled in the art will appreciate, however, that other limits on the number of requests, periods of time, and fee structures (e.g., charge per request) may be used without departing from the scope of the invention. The fee also may allow the corresponding user to customize the format of his or her requests.

The users are granted access to the system 102 when the e-mail address or phone number of their communication device 101 is added to the subscriber list. Any time the processing system 102 receives a request, it verifies that the request contains an e-mail address or phone number in the subscriber list prior to responding to the request. Advantageously, each user is granted access to the processing system 102 regardless of what entity, such as a communication service provider, provides the user with an ability to communicate using the device 101.

It is to be understood that the exemplary embodiments are merely illustrative of the present invention and that many variations of the above-described embodiments can be devised by one skilled in the art without departing from the scope of the invention. For instance, although the various examples used herein often describe providing stock quotes or sports scores, one skilled in the art will appreciate that any type of information may be provided, such as stock quotes, weather updates, directory assistance, airline updates, movie showtimes, search engine results, and other information. It is therefore intended that all such variations be included within the scope of the following claims and their equivalents.

What is claimed is:

1. A method for processing a data request, the method comprising:
receiving a data request in a first format from a mobile communication device;
translating the data request into a query having a second format;
submitting the query to a data storage system, wherein the data storage system understands the second format;
receiving a response to the query from the data storage system;
translating the response into a translated response having a third format understandable by the mobile communication device; and
transmitting the translated response to the mobile communication device.

2. The method of claim 1, further comprises the steps of:
receiving a second data request subsequent to the first data request, wherein the second data request requests information in addition to the translated response, wherein the second request has a same or less complexity than the first data request;
translating the second data request into a second query having the second format;
submitting the second query to the data storage system;
receiving a second response to the second query from the data storage system;
translating the second response into a second translated response having the third format; and
transmitting the second translated response to the mobile communication device.

3. The method of claim 1, further comprises the step of validating the data request to ensure that the request is from an authorized user.

4. The method of claim 3, further comprising the step of charging the authorized user a fee.

5. The method of claim 1, wherein the first format is an e-mail format and the third format is an e-mail format.

6. The method of claim 1, wherein the first format is a text-message format and the third format is a text-message format.

7. The method of claim 1, wherein the response includes data representing an image.

8. The method of claim 1, wherein the response includes data representing sound.

9. The method of claim 1, wherein the translated response is transmitted to the device in real-time.

10. The method of claim 1, wherein the mobile communication device is a mobile phone, a hand-held integrated e-mail device, a two-way pager, a BlackBerry, or a PDA.

11. The method of claim 1, wherein a type of information requested by the data request and an object for which the type of information is requested are determined by an address to which the data request is sent.

12. The method of claim 1, wherein a type of information requested by the data request is determined by an address to which the data request is sent, and wherein an object for which the type of information is requested is determined by information included as content in the data request.

13. The method of claim 1, wherein a type of information requested by the data request and an object for which the type of information is requested are determined by information included as content in the data request.

14. The method of claim 1, wherein a type of information requested by the data request and an object for which the type of information is requested are determined according to rules predefined by a user of the mobile communication device.

15. A method for processing a data request, the method comprising:
receiving a data request in a first format from a mobile communication device, wherein the first format is an e-mail or a text-message format, wherein the mobile communication device is a mobile phone, a hand-held integrated e-mail device, a two-way pager, a BlackBerry, or a PDA, and wherein at least a type of information requested by the data request is determined by an address to which the data request is sent;
validating the data request to ensure that the request is from an authorized user;
translating the data request into a query having a second format;
submitting the query to a data storage system, wherein the data storage system understands the second format;
receiving a response to the query from the data storage system;
translating the response into a translated response having a third format understandable by the mobile communication device, wherein the third format is the same as the first format;
transmitting the translated response to the mobile communication device in real-time; and
charging the authorized user a fee.

16. A computer-accessible memory storing computer code for implementing a method for processing a data request, wherein the computer code comprises:
code for receiving a data request in a first format from a mobile communication device;
code for translating the data request into a query having a second format;
code for submitting the query to a data storage system, wherein the data storage system understands the second format;
code for receiving a response to the query from the data storage system;
code for translating the response into a translated response having a third format understandable by the mobile communication device; and
code for transmitting the translated response to the mobile communication device.

17. The computer-accessible memory of claim 16, wherein the computer code further comprises:
code for receiving a second data request subsequent to the first data request, wherein the second data request requests information in addition to the translated response, wherein the second request has a same or less complexity than the first data request;
code for translating the second data request into a second query having the second format;
code for submitting the second query to the data storage system;
code for receiving a second response to the second query from the data storage system;
code for translating the second response into a second translated response having the third format; and
code for transmitting the second translated response to the mobile communication device.

18. The computer-accessible memory of claim 16, wherein the computer code further comprises code for validating the data request to ensure that the request is from an authorized user.

19. The computer-accessible memory of claim 16, wherein the first format is an e-mail format and the third format is an e-mail format.

20. The computer-accessible memory of claim 16, wherein the first format is a text-message format and the third format is a text-message format.

21. The computer-accessible memory of claim 16, wherein the response includes data representing an image.

22. The computer-accessible memory of claim 16, wherein the response includes data representing sound.

23. The computer-accessible memory of claim 16, wherein the translated response is transmitted to the device in real-time.

24. The computer-accessible memory of claim 16, wherein the mobile communication device is a mobile phone, a hand-held integrated e-mail device, a two-way pager, a BlackBerry, or a PDA.

25. The computer-accessible memory of claim 16, wherein a type of information requested by the data request and an object for which the type of information is requested are determined by an address to which the data request is sent.

26. The computer-accessible memory of claim 16, wherein a type of information requested by the data request is determined by an address to which the data request is sent, and wherein an object for which the type of information is requested is determined by information included as content in the data request.

27. The computer-accessible memory of claim 16, wherein a type of information requested by the data request and an object for which the type of information is requested are determined by information included as content in the data request.

28. The computer-accessible memory of claim 16, wherein the computer code further comprises code that allows a user of a mobile communication device to predefine one or more rules for determining the type of information requested by the data request and an object for which the type of information is requested.

29. A system for processing a data request, the system comprising:
a data storage system; and
a processing system communicatively connected to the data storage system and configured at least to:
receive a data request in a first format from a mobile communication device;
translate the data request into a query having a second format understandable by the data storage system;
submit the query to the data storage system;
receive a response to the query from the data storage system;
translate the response into a translated response having a third format understandable by the mobile communication device; and
transmit the translated response to the mobile communication device.
